(19) United States
(12) Patent Application Publication
(10) Pub. No.: US 2007/0134380 A1
(43) Pub. Date: Jun. 14, 2007

(54) Method and system for sanitization of grain products

(76) Inventors: William L. Vetter, Park City, VT (US); John Watkins, Idaho Falls, ID (US); Lynn Johnson, American Falls, ID (US)

Correspondence Address: KIRTON AND MCCONKIE, 60 EAST SOUTH TEMPLE,, SUITE 1800, SALT LAKE CITY, UT, 84111, US

(21) Appl. No.: 11/300,096

(22) Filed: Dec. 13, 2005

(51) Int. Cl. A23L 3/3409

(52) U.S. Cl. 426/320

(57) ABSTRACT

A method and system for sanitizing grain products, and more particularly, a method and system for using improved ozone treatment techniques and systems to sanitize grain products.

### RELATED APPLICATIONS

This application claims priority to U.S. patent application, Ser. No. 10/243,558, filed Sep. 13, 2002, entitled PATHOGEN CONTROL ON AGRICULTURAL COMMODITIES, U.S. patent application, Ser. No. 10/943,389, filed Sep. 17, 2004, entitled PATHOGEN CONTROL ON AGRICULTURAL COMMODITIES and U.S. patent application, Ser. No. 11/228,928, filed Sep. 16, 2005, entitled METHOD FOR REMOVAL OF INSECTS AND THE PREVENTION OF INSECT INFESTATION IN TRANSIT.

### BACKGROUND

1. Field of Invention

The present invention relates to a method and system for sanitizing grain products, and more particularly, to a method and system for using improved ozone treatment techniques and systems to sanitize grain products.

2. Background and Related Art

During the storage and transfer of grain from harvest to final processing, there exists the high probability that organisms such as molds, fimgi, and associated spores will contaminate the grain. Insect infestation is also problematic. Contaminated grain can emit an unpleasant odor and can even render grain unusable. The United States Department of Agriculture (USDA) tests grain and grades it, specifying for which uses the grain qualifies. Sometimes the USDA deems grain non-saleable. This testing process is sometimes referred to as Surveying. The person performing the testing is often called the Surveyor.

The grain industry utilizes various techniques to treat infected grain to allow it to be deemed saleable by the Surveyor. For instance, if the specific deficiency is insect infestation, then the industry utilizes chemical treatments, such as methyl bromide, hydrogen cyanide and phosphine. The Montreal Protocol listed these chemicals as hazardous and slated them for delisting sometime during 2006-2007. The industry combats mold contamination through a process known as “blending.” The blending process mixes bad grain with saleable grain in order to meet minimum specifications, as long as the levels of mold contamination are not significant. If the level of mold contamination is excessive and in the case of prominent odor (e.g. sour grain), there are virtually no remedies other than extensive blending (grain that has been deemed by the surveyor as sour cannot be blended and must be segregated). Blended grain's lower quality results in a lower selling price and consequently a direct reduction in revenue. Discount rates for blending can reach levels of 10% of the market value of the product. In certain cases, sour grain cannot be sold and is taken to landfills for disposal.

At any given time, the United States grain industry stores twenty-one billion (21,000,000,000) bushels of grain. A conservative estimate of the volume of grain that could be considered as marginal or not meeting minimum Surveyor specifications is 12%-17% or a maximum of 3,570,000,000 bushels. Thus, contaminated grain causes significant losses for the agricultural community.

To further exacerbate these problems, the storage capacity for grain in the United States is approximately 78% of the amount the industry produces. This storage space shortage results in the grain being stored in “Grain Piles” on the ground. In this condition, the grain is unprotected from infestation by insects and provides an environment conducive to the growth and proliferation of mold and fungal growth.

The agricultural community desires treating all, or as much of the spoiled grain as is possible, for the purpose of restoring it to a usable and saleable condition. Ozone treatment is one way known to treat and prevent spoiled grain. Ozone is one of the world's strongest oxidants. Generated as the by-product of an electrical discharge (also referred to as corona discharge), electrical energy splits the oxygen molecule (O2), which then recombines single oxygen atoms to create a highly reactive O3 molecule-ozone. This technology has been in use since the early 1800's for use in the purification of air, water, and waste streams and continues to be used throughout the world for purification and pathogen control. For example, O3Co, an Idaho corporation, perfected a means to expose potatoes to high doses of ozone (>200 parts per million) through a tunnel process that guaranteed the transfer of the gas onto the surface of the tuber. As a result of this treatment, the predominant bacterial contaminant, erwinia, was virtually eliminated from the surface of the potato, thereby ensuring its viability during the storage period.

Thus, while the industry has made improvements in treating grain, more improvements are needed because there are still conditions that exist with current storage technologies that prohibit the effective ozonation of grain. For instance, the height of the current storage units creates installation and safety difficulties. In addition, the inlet/discharge configuration requires extensive and expensive retrofitting. Current storage systems also have limited connection points for ozone injection and poor fluid dynamic designs that create channeling effects through the grain. The multiple styles of current storage facilities include steel storage containers that hold between 5,000 to 55,000 bushels, concrete bins with up to 250,000 bushel capacity and rectangular or circular concrete bunkers (ground piles) with up to 2,000,000 bushel capacity.

Also, the air handling systems within the storage units handle only 0.1 cubic feet of air per minute (cftn) per bushel. This amount is too low for the adequate transference of ozone gas. Current systems are also inadequate because they do not have return air systems and have limited power availability. Ozone generating equipment requires high amperage draw-systems necessary to treat large ground piles that would exceed facility capabilities.

In addition, current systems often over-ozonate grain products. Over-ozonating is harmful to food products. For instance, too much ozone produces dark spots on potatoes and can make grain odorous.

Thus, it is clear the agricultural industry needs an improved method and system for sanitizing grain products, and more particularly, a method and system for using improved ozone treatment techniques and systems to sanitize grain products.

### SUMMARY OF THE INVENTION

The present invention relates to a method and system for sanitizing grain products, and more particularly, to a method and system for using improved ozone treatment techniques and systems to sanitize grain products. More particularly, some embodiments consist of the Ozo-Blast-AG (hereafter known as System), which is a treatment system and method that addresses all of the engineering aspects, which have created difficulties in the implementation of the technology on a large scale. This technology incorporates a proprietary manifold system for the injection of the gas, critical airflow and velocity design to maximize the efficiency of the transference of gas while at the same time reducing treatment time, conditioning of the inlet air, and utilization of the return air to ensure a closed-loop design. This process chamber is directly connected to the O3Co ozone generator, as disclosed in U.S. patent applications, Ser. Nos. 10/243,558, 10/943,389 and 11/228,928, that provides the appropriate output to maximize the efficiency of the System.

As discussed in part above, O3Co developed and manufactures equipment used in the treatment of potatoes, onions, produce, and grain products. O3Co manufacturers this equipment with the purpose of the generation of ozone gas in concentrations capable of control and elimination and/or eradication of pestilent contaminants on agricultural products. O3Co developed a process chamber with an integrated ozone generator and methodology in which grain may be placed, treated, and restored to saleable quality. The process chamber treats grain for mold, odor, and insect infestation utilizing an organic product, which has no residual effects on the grain being treated, the environment or those involved in the treatment process. The chamber does not require positive pressure or vacuum for use and operates under an ambient and slight negative pressure atmosphere.

The philosophy behind the design of the equipment is to provide the agricultural community with a device that allows for the treatment of grain of questionable or non-saleable condition in an efficient, safe, and cost-effective methodology. Testing by Purdue University and O3Co has proven the efficiency of the ozonation process. However, due to difficult engineering issues surrounding the current storage facilities, the treatment of grain is cost and safety prohibitive. Further, the cost-effectiveness of the treatment is diminished if one is required to treat all of the grain rather than the percentage of grain that does not meet specifications. The size and associated cost of manufacturing ozone generating equipment to meet the demands of treating these large volumes is further not cost effective. Therefore, some embodiments treat 100% of the diminished product safely and efficiently in a closed-loop containment system.

Utilizing the expertise that O3Co secured from its earlier ozone-related systems, O3Co conducted research at various agricultural universities. This research resulted in transferring O3Co's technology to the treatment of grain for the purpose of mold, odor, and insect control. Unlike potatoes, grain offers numerous challenges, such as the nature of the contaminants (e.g. dormant spores), density and compaction rates of grain, the manner in which ozone permeates the product, and the auxiliary components necessary to move ozone through the grain. Researchers completed extensive analysis in the field and through the agricultural universities in an effort to achieve a viable and cost-effective utilization of ozone for pathogen control.

The critical aspects of the preliminary research were primarily the engineering considerations required to inject ozone into existing storage facilities; low air transfer rates within these facilities and materials; the volumes of grain to be treated; and the resultant amounts of ozone required to reach the infected regions at concentration levels necessary to provide for a positive outcome; namely the eradication and elimination of pests. Further, the design of the storage facilities do not lend themselves to easy handling of the ozone gas. More specifically, current storage facilities have insufficient blower capacity, no return air ducting, poor internal flow design and safety concerns (e.g. containment of the gas during and after processing).

The System is not simply an incorporation of an ozone generator and grain silo. The System is complex and takes into consideration and methodology the efficient use of ozone. In consideration of the volume and concentration of ozone required to “treat” the grain, one embodiment considers time, concentration, and adequate airflow. Further, the greater the volume of grain treated, the greater the amount of ozone required to achieve a positive outcome. If the end-user decides to decrease treatment time, they would then need to increase the concentration or reduce the volume to be treated. With an increase in output, there is a substantial requirement for power to operate the equipment. At some point, the power requirements exceed the standard accessible power connections. Thus, the power requirements become a limiting factor to the volume of grain that can be treated.

Another aspect of a preferred embodiment of the System design is the air handling system. Without adequate airflow, the migration of ozone throughout the grain, regardless of concentration, is minimal. The System calculates the airflow coefficients relative to the density and the compaction factors for each type of grain in relation to the ozone output. Optimizing these factors results in the generation of ozone concentrations that is high enough for a positive outcome. The simple addition of ozone in a high concentration will not guarantee the complete treatment of the grain. Further, in order to reduce the treatment period, the System utilizes an internal return air system that maintains a closed-loop design. This allows for a minimal exchange of outside air, providing a three-fold benefit—the multiple use of the ozone generated (decreased period of time required to establish a concentration gradient); less changes in the moisture content of the grain by rapid air exchange for the outside; and prevention of the gas from escaping to the outside of the vessel and thus requiring treatment.

During the process of treating grain with ozone, critical airflow must be combined with the appropriate output (Kg/Hr) of ozone gas. Since the concentration of ozone gas is directly proportional to the volume of air in which the gas is mixed, the configuration of the air handling system is a major component to the design. Further, the physical characteristics of ozone, despite the fact that it is heavier than air, lends itself to not actively moving in any direction without physical assistance or the use of an assist gas—both of which are included in a preferred embodiment of the system design and methodology. These fluid flow characteristics also vary with the type of grain that the System treats. Thus, the System has the ability to adjust airflow/output values in consideration of these effects. In order to ensure turbulent flow and mixing of the ozone in the air stream, the System uses a proprietary mixing manifold. Ozone tends to be non-ubiquitous and despite its high reactivity will not quickly mix in an air stream. The proprietary mixing device ensures this effect.

In a preferred embodiment, the ozonation of grain is characterized by a 2-phase gas transfer process. Since ozone is an indiscriminant oxidizer, it seeks-out all forms of organic material to attack. In a standard storage facility, the amount of extraneous organic material could be large, dramatically increasing the time for treatment. Phase 1 of the treatment process involves the preliminary conditioning of the grain, as well as the storage facility. Under normal conditions this could take days or weeks. Future treatment of the grain for the first time and subsequent treatments that may be required fall under Phase 2. During this treatment, Phase 2 is the free-flow of ozone through the grain. In this process, the treatment time is reduced to hours.

In one embodiment, the Ozo-Blast-AG process chamber is specifically designed to minimize the contact areas in which extraneous organic material may reside. The design of the chamber is such that the Phase 1 time is minimized and the treatment process is more indicative of Phase 2 process.

Safety is an important aspect of the System's design. The Environmental Protection Agency (EPA) specifies that personnel cannot be in a confined space with ozone levels exceeding 0.1 parts per million (ppm) for an 8-hour period. A concern over the utilization of current technology for the treatment of grain in existing storage facilities is the ability to contain the gas and then provide for a means in which to reduce it back to pure oxygen after treatment. In a preferred embodiment, the System addresses this concern by integrating a closed-loop design. Further after the System has treated the grain in accordance to computer-generated analysis, the System ceases applying ozone to the grain. However, the air handling continues to operate and thus reduces the concentration of the ozone to acceptable levels. All inlet and outlet connections are interlocked until those levels are achieved.

In consideration of the critical design aspects of airflow, concentration, and containment, the Ozo-Blast-AG System further utilizes a computer system to calculate the pertinent parameters associated with the particular types of grain (namely type, density, compaction rate) as well as the handling of the grain (metering of the volume to be treated and safety interlocks) to ensure that each treatment process is designed specifically for the application regardless of volume, type, or condition of the grain. The System has the ability to make program changes based on these parameters, monitor them during processing and provide a report at the end of the treatment process. Each process is logged and integrated into the analysis system as a device that continues to improve the process and minimize processing time.

In sum, some embodiments provide a complete, self-contained system that treats selected products with ozone to remove odor, eliminate mold, and kill insects that have infected the product. Some embodiments also provide a means to load the product into the system, to determine the amount of product present, and then unload the product from the system after it has been treated. It also provides the automatic isolation of all entry points into the system prior to the injection of ozone. In other embodiments, the system and method regulates and controls the flow of the treatment gas based on the type of product being treated to ensure that the entire product is in contact with the ozone. In addition, some embodiments monitor parameters throughout the system to ensure that the treatment gas is applied in the correct concentrations. Some embodiments also monitor critical system parameters and shut down the system to a safe condition in the event of a malfunction or in the event the system is tampered with. It provides remote indication as to the status of the system and whether the unit was shut down and why. Some embodiments provide complete containment and recirculation of the treatment gas such that there is no release of ozone to the atmosphere.

While the methods and processes of the present invention have proven to be particularly useful in the area of grain sanitization, those skilled in the art can appreciate that the methods and processes can be used in a variety of different applications and in a variety of different areas of manufacture to yield improved crop preservation results.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The foregoing and other features of the present invention will become more fully apparent from the accompanying drawings when considered in conjunction with the following description and appended claims. Although the drawings depict only typical embodiments of the invention and are thus, not to be deemed limiting of the invention's scope, the accompanying drawings help explain the invention in added detail.

FIG. 1 illustrates a cross-sectional view of a representative system; and

FIG. 2 illustrates a plan view of a portion of the representative system.

### DETAILED DESCRIPTION OF THE INVENTION

It is emphasized that the present invention, as illustrated in the figures and description herein, can be embodied in other forms. Thus, neither the drawings nor the following more detailed description of the various embodiments of the system and method of the present invention limit the scope of the invention. The drawings and detailed description are merely representative of the particular embodiments of the invention; the substantive scope of the present invention is limited only by the appended claims. The various embodiments of the invention will best be understood by reference to the drawings, wherein like elements are designated by like alphanumeric character throughout.

This invention relates to the field of the treatment of grain and/or grain products, hereafter referred to as grain. The use of the term grain also includes, but is not limited to corn, wheat, soybean, milo, barley, and sorghum and any other related item that would benefit from the elimination and eradication of odor, mold and other biological pathogens and insects.

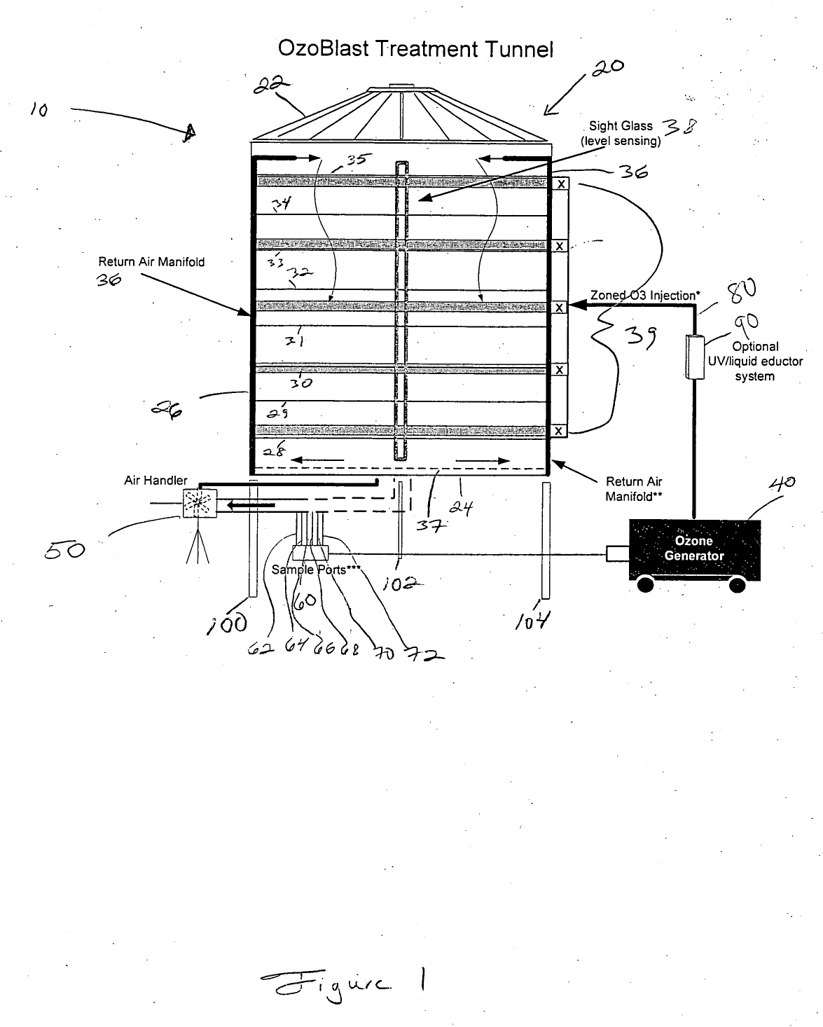

With reference now to the accompanying drawing, FIG. 1 depicts a cross-sectional view of a representative system. More specifically, FIG. 1 depicts an Ozo-Blast-AG System 10 that includes process chamber or grain silo 20, an ozone generator 40, an air handling system 50, monitoring ports 60, an ozone injection line 80, a UV/liquid eductor system 90, a first process chamber support 100, a second process chamber support 102, and a third process chamber support 104.

In this embodiment, process chamber includes a roof 22, a floor 24, an outer wall 26, a first level 28, a second level 29, a third level 30, a fourth level 31, a fifth level 32, a sixth level 33, a seventh level 34, an eighth level 35, a return air manifold 36, a perforated flow and grain handler/hopper bottom 37, a level sensing sight glass 38, and a series of ozone injection valves 39.

The perforated flow and grain handler/hopper bottom 37 facilitates the loading and unloading of grain before and after treatment. The ozone generator 40 injects ozone into the process chamber 20 via the ozone injection line 80. In some embodiments, the ozone first passes through the UV/liquid eductor system 90, which uses an eductor to inject ozone into a ubiquitous liquid and then passes it through a UV light prior to injection onto the product to be treated. The ozone then enters the process chamber 20 through the series of ozone injection valves 39. When a sufficient amount of ozone has entered the process chamber 20, the series of ozone injection valves 39 are closed so that no ozone escapes. The ozone injection valves 39 also control the flow of ozone coming into the system.

In a preferred embodiment, the nominal volume for treatment process is 55,000 bushels with the process chamber 20 height being 30′ and the diameter being 54′. The volume of the process chamber 20 in this embodiment is approximately 68,750 cubic feet with a grain ratio of 1.25 cubic feet per bushel. With the corresponding process chamber 20 height, air flow considerations would range from 18,000 to 35,000 cfm to optimize the treatment process. Design of the process chamber 20 (height/diameter) is not as critical as the internal design.

In consideration of these physical designs, the corresponding target velocities would be 0.75+/−0.25 cfin/bushel with associated volumetric air output. Ozone production for the desired treatment would approach 10-15 grams per bushel at varying and adjustable airflow rates to create the necessary concentrations of ozone (ppm) to eradicate odor, mold and insects. Each condition would require a different concentration level in accordance to the condition of the grain and its physical characteristics namely the type, density, compaction factor, moisture content and temperature.

The Ozo-Blast-AG System 10 simultaneously tracks all of the aforementioned parameters and adjusts the airflow inlet to increase or decrease the concentration based on need to accomplish the task. For some embodiments, a concentration between 10 and 250 ppm creates an environment which rapidly and cost effectively treats the product. Because it is important to provide the appropriate concentration of ozone, the air handling system 50 and monitoring ports 60 help to monitor and adjust the ozone concentration. For example, in some embodiments, the monitoring ports 60 includes an ozone monitoring line 62, a moisture monitoring line 64, a temperature monitoring line 66, an odor line 68, an air flow line 70 and a grain level line 72. These lines associated with the monitoring ports 60, work in conjunction with the level sensing sight glass to ensure the proper level of ozone concentration.

Due to the aforementioned factors which will affect the conditions under which the grain is being treated, it is not practical to spell out the specific engineering data for each and every possibility, but rather to provide a range in which the device can operate in order to maximize the efficiency of the design.

The closed loop design of the air handling system 50 circulates the ozone through the return air manifold 36 and allows the Ozo-Blast-AG System 10 to re-use the ozone, maintain a constant moisture content of the grain and prevent gas from escaping the process chamber 20.

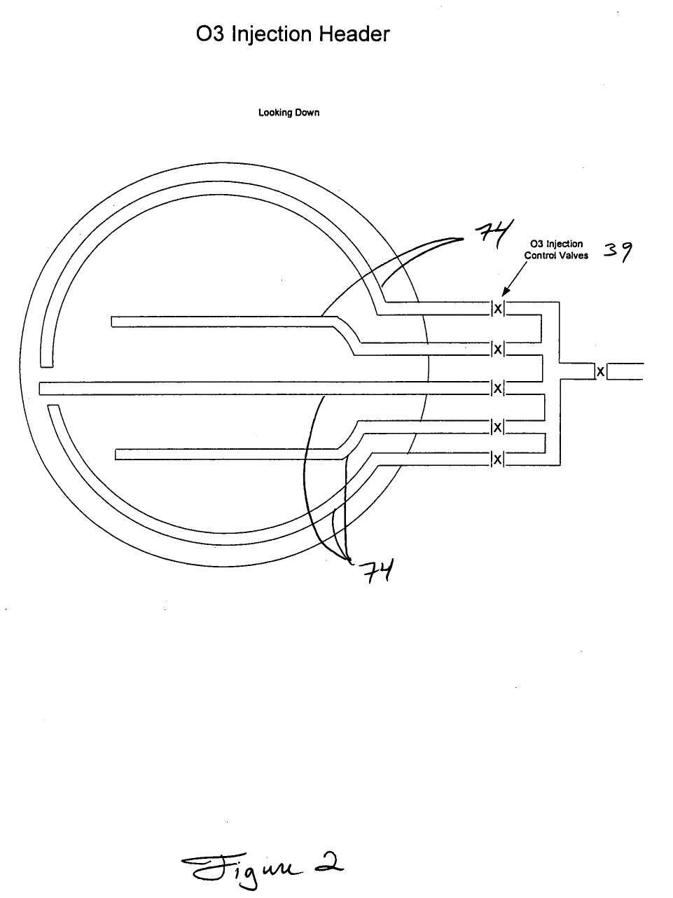

FIG. 2 depicts a plan view of a portion of the representative system. More specifically, FIG. 2 shows the series of zone injection valves 39 and their accompanying inside injection lines 74, which are spread apart to give adequate distribution of the ozone inside the process chamber 20.

Thus, as discussed herein, the embodiments of the present invention embrace a method and system for sanitizing grain products, and more particularly, to a method and system for using improved ozone treatment techniques and systems to sanitize grain products.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for sanitizing grain comprising the steps of:
loading grain into a process chamber;
introducing ozone into a chamber;
preventing the ozone from exiting the chamber;
monitoring a concentration of the ozone within the chamber to maintain the concentration between 10 and 250 ppm throughout the entire chamber;
re-circulating the ozone within the chamber; and
un-loading the grain from the chamber.

2. The method of claim 1, further comprising the step of monitoring the concentration of ozone based on a condition selected from the group consisting of::
a) type;
b) density;
c) compaction factor;
d) moisture content; and
e) temperature.

3. The method of claim 1, further comprising the step of achieving a volumetric air output of between 0.75+/−0.25 cfm per bushel.

4. The method of claim 1, further comprising the step of producing between 10 and 15 grams per bushel of ozone.

5. The method of claim 1, further comprising the step of maintaining the air flow in the range of between 18,000 to 35,000 cfm.

6. The method of claim 1, further comprising the step of repeating the step of re-circulating until all mold is destroyed.

7. The method of claim 1, further comprising the step of repeating the step of re-circulating until all insects are destroyed.

8. The method of claim 1, further comprising the step of treating the grain for mold, bacteria, fungi, and odor.

9. The method of claim 1, further comprising the step of automatic shutdown of the system in the event of a malfunction.

10. A system for sanitizing grain comprising:
a process chamber for holding grain in need of de-contamination;
an ozone generator that provides ozone into the chamber;
an air handling system that re-circulates the ozone within the chamber, wherein the air handling system includes a return air manifold;
monitoring ports that monitor the concentration of the ozone within the chamber;
at least one level for holding grain;
a level sensing sight glass; and
a series of zone injection valves.

11. The system of claim 10, wherein the volume of the process chamber is approximately 68,750 cubic feet with a grain ratio of 1.25 cubic feet per bushel.

12. The system of claim 10, further comprising a UV/liquid eductor system.

13. The system of claim 10, further comprising a perforated flow and grain handler/hopper bottom.

14. The system of claim 10, further comprising an ozone injection line that transports the ozone from the ozone generator to the chamber.

15. A method for sanitizing grain comprising the steps of:
loading grain into a process chamber;
introducing ozone into a chamber;
preventing the ozone from exiting the chamber;
monitoring a concentration of the ozone within the chamber to maintain the concentration between 10 and 250 ppm throughout the entire chamber, wherein the monitoring is based on a condition selected from the group consisting of:
a) type;
b) density;
c) compaction factor;
d) moisture content; and
e) temperature;
re-circulating the ozone within the chamber;
achieving a volumetric air output of between 0.75+/−0.25 cfm per bushel;
maintaining the air flow in the range of between 18,000 to 35,000 cfm; and
un-loading the grain from the chamber.
